(19) United States
(12) Patent Application Publication
(10) Pub. No.: US 2002/0193973 A1
(43) Pub. Date: Dec. 19, 2002

(54) Passenger moving space guide system

(75) Inventors: Kiyotaka Kinoshita, Kawasaki (JP); Yoshihisa Ishigami, Yokohama (JP); Haruo Amano, Osaka (JP); Akira Umetsu, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/151,904

(22) Filed: May 22, 2002

(30) Foreign Application Priority Data
Jun. 14, 2001 (JP) 2001-179676

(51) Int. Cl. G06F 17/50

(52) U.S. Cl. 703/1

(57) ABSTRACT

A passenger moving space guide system for guiding a large number of passengers who gather in a facility in a certain time and for providing various kinds of necessary information for the passengers. The system includes an information center 19 located in the periphery of the entrance/exit of the facility, where information and guide services related to travel are provided; a security facility 13, located adjacent to the information center 19, for performing security inspections; and a hall 15 arranged along with the security facility. The hall 15 includes convenient service functions for passengers, such as Internet rooms, conference rooms, nursery rooms, medical treatment rooms, restaurants, snack bars and shops, as well as a passenger check-in facility for accepting check-in, an immigration/emigration inspection facility, a passenger boarding guide facility, an air travel agent facility and an airline's passenger reception facility in a comprehensive manner.

### BACKGROUND OF THE INVENTION

1. Field of the Invention

The present invention relates to a passenger moving space guide system with the aim of providing the security management and smooth moving guide for passengers who use a facility such as an airport.

2. Description of Related Art

Referring to airplanes as an example, in 2005, for instance, super jumbo airplanes such as A380 (with a capacity of 700 people for international flight, and a capacity of 950 people for domestic flight) are scheduled to be placed in domestic lines and international lines in Japanese base airports including Narita, Haneda, Kansai, Fukuoka, Sapporo and New Central Japan Airports.

The placement of such super jumbo airplanes may cause imperfection of security management and serious crowdedness in processing a large number of passengers, cargo and baggage, and customs, immigration/emigration and quarantine inspection procedures. In order to prevent such serious crowdedness, it is necessary to review the function and facilities of the individual passenger terminal buildings entirely and construct new designs.

In the coming era in which a large number of passengers are carried by super jumbo airplanes, an airport has airplanes engaged in international lines which are operated on a three departures and two arrivals per hour basis as a standard. A total of 3,500 international passengers per hour, including 2,100 departing passengers and 1,400 arrival passengers, would gather in a certain area.

Regarding domestic lines, 3,800 departing passengers of four departing planes and 2,850 arrival passengers of three arrival planes per hour are expected, and thus a total of 6,650 passengers per hour would gather in a certain area. The scale and structure of the current terminals are not sufficient for processing such a large number of passengers, and it is therefore necessary to plan for the reconstruction and expansion of terminal buildings. However, it would take a long construction period and a lot of costs to achieve this. Hence, there are demands for a new space utilizing large hall which can be built in the existing facilities of any airports, and new basic information communications which can simplify the airport operations rationally, provide the security management and systematize optimum guiding services. Without satisfying these demands, there is an anxiety about reoccurrence of confusion of plans which occurred in an early stage of accepting the current Boeing 747 airplanes and a blunder which was made as a result of taking claptrap measures.

Referring to an airport as an example, departing passengers who use the current passenger terminal go through the processes of ticketing, reservation, check-in for boarding, baggage check-in, and checked baggage inspections at the terminal ticket lobby. Subsequently, the passengers may use snack bars, restaurants, shops, banks, etc. at the departure lobby, and then go through passenger body check and carry-on baggage inspections at the security check area, enter the emigration inspection area for emigration inspections and customs inspections, use services such as tax-free shops, snack bars, restaurants and shops in the departure waiting room until their boarding time, pass through the boarding passenger moving pathway, and board their airplanes at the boarding gate lounge. Since the moving space for departure is designed in such a fashion, the passengers suffer from crowdedness, risk of incorrect boarding, and long time waiting.

At present, after an airplane stops at the apron, the immigration passengers who use the passenger terminal enter the immigration inspection area via the immigration loading bridge, present their passport and immigration card for the approval seal of entering a country, and then enter the customs inspection area to collect their baggage from a baggage claim carousel. If the passenger's baggage is within a certain duty-free exemption, the passenger can proceed to the arrival lobby without going through inspections. On the other hand, if one's baggage exceeds the duty-free exemption or if the passenger brings baggage for other reasons, he/she submits the declaration indicating this and the quarantine declaration to the customs and quarantine authorities, and exits the airport via the immigration arrival lobby after inspections. Since the moving space for entering a country is designed in such a fashion, the passengers suffer from long time waiting due to the crowdedness like the departure case.

Passengers who use a global hub international airport for transit purpose enter a waiting room provided exclusively for transit passengers via a specified pathway from their airplanes, and wait until their boarding time. According to international statistics, the passengers' waiting time is around three to five hours on average, and the passengers would stay in the waiting room longer if their flights are operated late at night. Since the current waiting room space is extremely small, it is difficult for the passengers to secure their seats, and a large number of passengers sit down directly on the floor. This makes the room very crowded, and the environmental conditions are extremely poor ones for females, aged people, children and physically handicapped people. Hence, the current waiting room provided exclusively for passengers does not take sufficient measures to prevent or avoid accidents.

Moreover, the airport information conventionally provided for the passengers has the following problems. In the provided airport information, flight information, passenger guide information, airplane operation information, immigration/emigration, customs and quarantine information are individually systemized and used by the airlines, the airport company, the airport authority, and the CIQ (Customs, Immigration and Quarantine) Offices, respectively, according to the types of the information. Since the information is managed by each organization and is not linked with information provided by other organizations, the passengers cannot obtain appropriate information quickly, resulting in accidents such as flight missing and incorrect boarding. Although the flight information is broadcasted partly by radio and television, such broadcasting is done only for limited occasions such as the cancellation of flights due to bad weather, and is not provided on a regular basis.

Furthermore, operation control information, airway information, aviation weather information, immigration/emigration control information, customs information and quarantine information are not announced for ordinary passengers, people who come to see off or meet the passengers, and general users. Since the passengers cannot benefit from conveniences of such information, some inconvenience is caused.

In order to rationally operate the airport facilities, there is a need to control the information environment for a large number of passengers, build an integrated system of people, goods and information, and secure smooth mobility. In addition, there is urgent demand for systematization of building of a new airport general information communication system, for shortening of time taken for security measures, boarding, check-in procedures, etc.

Conventionally, airlines lead and guide their passengers by notice boards, announcement by voice and guidance terminals. Regarding check-in for boarding, etc., since a check-in desk is provided, the passengers go to the desk and follow the procedures. Note that, for confirmation of reservations and a variety of information such as boarding information, questions and answers are often made orally at the check-in desk. However, if a large number of passengers gather, management of security cannot be ensured and guidance and information cannot sufficiently be provided smoothly, and accidents such as incorrect boarding and flight missing would occur. Moreover, since the passengers and people who come to see off or meet the passengers are mixed, there is often confusion in the facility.

Since the airport facility has huge area, many passengers who use the airport for the first time would get lost. Since the number of staff is limited compared to a large number of passengers, people who come to see off or meet the passengers and general users, the staff often cannot deal with these people in a sufficient manner. Moreover, announcement by voice cannot be conveyed to aurally handicapped persons. In particular, when announcement by voice is directed to such a person, a problem occurs.

In recent years, automation is promoted in airports, and guidance about the facilities in the airports is offered using guidance terminals. However, since the guidance terminals are used by a number of unspecified people, the content of guidance is limited to guidance on the positions of the facilities in an airport at most, and thus this service is far from a level of satisfying the individual's demand and offering comfortable travel. Even if the terminal has a variety of functions, there is a problem that the operation becomes complicated since the user must specify his/her desired information in detail.

Regarding the global hub international airports, it is considered that the capacity limit of a single passenger terminal building is around 20,000,000 people per year. There is an international standard that proposes an airport which has a number of passengers exceeding the above-mentioned number per year to adopt a multi-terminal system.

For the acceptance of super jumbo airplanes such as A380 which will be placed in or after 2005, the multi-terminal system may be adopted. In general, the multi-terminal system merely adopt a plurality of functions and facilities of currently existing single terminal system. The multi-terminal system is, however, not a realistic idea in many cases since this method requires high costs and long works in construction and also a new building site.

Moreover, stipulated in international guidelines is allocation ratio of each facility to the entire terminal function facilities in order to achieve smooth movement of a large number of passengers who gather in a certain area in a short time. To put it more concretely, 35% to 40% space is allocated for lease to airlines, 15% to 25% space for convenient services such as restaurants, shops and snack bars, 25% to 35% space for official use, and 10% to 15% space for maintenance and control.

In order to realize terminal function facilities which efficiently and rationally suit the era of large-scale passenger transportation, there is demand for development of a novel design concept which is designed to realize efficient use of terminal space, in place of the conventional space allocation.

After reconsidering the current space-utilization structure inside the terminal building, the present invention has an object to provide, in place of the current multi-terminal system method which requires high costs and long works, a passenger moving space guide system which is capable of using the current terminal facilities efficiently and rationally and is applicable to terminal facilities suited for the era of large-scale passenger transportation.

Suggested at first are to discontinue the above-mentioned space allocation in the terminal facilities, which is stipulated in the international guidelines, and to provide a design concept of terminal facilities which can ensure safety (security) of a large number of passengers and lead and guide the passengers smoothly.

According to the design concept of terminal facilities according to the invention, 80% of the entire building space is occupied by an arrivals/boarding guide large hall. In the hall, all of the check-in function, boarding inspection function, travel agent function, waiting room function, the facilities for executing boarding procedures such as reservation and issuance of airplane tickets, and baggage check-in facilities are comprehensively provided. Accordingly, precautions against accidents such as scattering of passengers, incorrect boarding and flight missing, which are the most important measures to be taken by airlines, should be put into effect, and smooth moving space should be secured for passengers.

### BRIEF SUMMARY OF THE INVENTION

The present invention has been made with the aim of solving the above problem, and an object thereof is to provide a passenger moving space guide system capable of security management and appropriately leading and guiding a large number of passengers who gather in a facility such as an airport in a certain time, and ensuring normal operations of transportation such as airplanes by providing for the passengers various kinds of necessary information for accurate departures and arrivals, quick movement, timeliness, and the convenience, comfort, inexpensiveness and environmental conservation which are achieved by space utilization.

In order to achieve the above object, the present invention comprises: an IT general information smart center, provided in the periphery of an entrance/exit of a facility, for providing information and guide services related to travel in general; a security facility, located adjacent to the IT general information smart center, for performing security inspections to prevent hijacking; and an international and domestic arrivals/boarding guide large hall arranged along with the security facility. In the international and domestic arrivals/boarding guide large hall, all convenient service functions for passengers, such as Internet rooms, conference rooms, nursery rooms, medical treatment rooms, restaurants, snack bars and shops, as well as a passenger check-in facility for accepting check-in, an emigration inspection facility, a passenger boarding guide facility, an air travel agent functional facility, and an airline's passenger reception facility are provided in a comprehensive manner.

The IT general information smart center has a facility server which connects and accesses to a variety of information servers of states, airlines, airport companies, air travel agents, etc. By communicating with these servers, the facility server centralizes information systems for combining and integrating aeronautic information, boarding guide information, flight control information, aviation weather information, airport facility information, risk management information, administration information, and financial and exchange information which are not conventionally announced for passengers, as well as boarding guide information and check-in procedure information, and immediately announces necessary information for the passengers. Moreover, the present invention comprises information obtaining means, including a fixed information terminal apparatus, a portable phone or a portable information terminal, which is capable of communicating with the facility server. Furthermore, the present invention includes a large-sized display unit, provided in the international and domestic arrivals/boarding guide large hall, for announcing administration information, risk management information, financial information, exchange information and currency exchange rates as well as flight information.

The portable phone or the portable information terminal can be used as a unit for transmitting information from the facility server. The portable phone or the portable information terminal can also be used as means for detecting a passenger's position in the facility. Furthermore, the portable phone or the portable information terminal comprises a reader for an image-attached smart passport card which is an IC card having a passport function, an airplane ticket/ship ticket function and a credit card function, and displays contents stored in a memory.

According to the present invention, it is possible to realize safe and rapid boarding and deplaning of a large number of passengers on/from an airplane, and to simplify immigration/emigration inspections, customs inspections and check-in. Moreover, since various kinds of airport information is newly created for preventative measures for security, it is possible to improve security countermeasures against crowdedness, congestion and accidents in the airport facility, rationalize the enlargement and reconstruction of the airport facility, and save labor for operation. Furthermore, the invention ensures a smooth flow of passengers, thereby realizing a comfortable environment for passengers.

The international and domestic arrivals/boarding guide large hall includes a boarding guide large hall and an arrival guide large hall. The international and domestic arrivals/boarding guide large hall according to the present invention dispenses with all the conventional facilities such as airlines' check-in counters, general waiting rooms, air travel agent facilities, convenient service facilities for passengers and a departure lobby, and newly includes these facilities in a comprehensive manner. The entrance of departing passengers in the large hall from the entrance hall of the terminal building via the security check facility can prevent accidents such as scattering of a large number of passengers, incorrect boarding and flight missing. Since the passengers gather in a certain area in a short time and board their airplanes rapidly and smoothly, it is possible to ease the movement of the passengers.

As a result, since the space of the area of the existing building is rationally utilized without making considerable expansion, it is possible to always control a large number of passengers and ensure accurate operation time for flights. The arrival passengers can also benefit from similar advantageous effects.

The domestic arrivals/boarding guide large hall can be constructed in the same scale with the exception of the CIQ facilities.

Conventionally, in addition to the space for lease in the passenger terminal, a common lobby having a large area is provided. Since the common lobby is set as a free lobby and cannot be changed to a pay lobby, it becomes one of the causes of financial difficulties. The CIQ inspection space is conventionally defined as national property. According to the present invention, there is a possibility that the entire area is dealt as national property because of the presence of the international and domestic arrivals/boarding guide large hall, and a big profit can be brought to operation of the airport.

By providing the international and domestic arrivals/boarding guide large hall, prompt movement of a large number of passengers and computerization of visual and oral guides are realized, thereby implementing thoroughgoing security and hijack countermeasures.

The departing passengers, after passing a security gate, confirm their flight reservations, flight information etc. through the IT general information smart center at the entrance of the facility, and wait in the boarding guide large hall until their boarding time. During waiting, the passengers can confirm necessary airport information using the fixed terminal apparatuses, and can also obtain boarding information such as the boarding gate to the airplane, boarding time, departure time, flight number, and airline name as final information.

The arriving passengers can, on board, obtain a variety of information about immigration/emigration formalities, customs formalities, quarantine formalities, the presence or absence of people who come to meet them, and baggage claim carousels concerning the arrival airport, using the fixed information terminal apparatuses in the airplane, and can save the processes of these formalities using the information necessary for deplaning in advance. Transit passengers can obtain a variety of information about transit airlines, flight number, departure time, immigration/emigration formalities, customs formalities and baggage processing through the fixed information terminal apparatuses in the airplane, and can reconfirm the information at the IT general information smart center located in a predetermined arrival guide large hall.

Domestic departing passengers use an airport general information communication system through an IT general information smart center located in the periphery of the entrance/exit of the facility so as to obtain a variety of information about their flight number, departing time, and the conditions of purchase and reservation of airplane tickets or ship tickets, and check-in, so that the passengers can clearly understand their own travel plan and the processes to board their airplanes.

Domestic arrival passengers go through the loading bridge from the airplane, collect their baggage at the baggage conveying facility, and proceed to the exit after confirmation of the baggage by the airline's baggage inspecting device. When the passengers have only carry-on baggage, they proceed directly to the exit via the arrival passenger pathway. Transit passengers confirm their flight reservation for transit airplanes at the IT general information smart center in the arrival guide large hall placed along with a lobby provided exclusively for transit purpose, and then wait.

For the airport operations, information services of the airport authority, the CIQ offices, airlines, airport buildings, in-flight meal factories, fuel suppliers, aircraft maintenance facilities, air travel agents and flight gift agents are operated connectively for 24 hours according to the daily flight schedules. It is therefore necessary to ensure a smooth flow of people who come to see off or meet passengers, general users and cargo. In order to prevent a situation that causes delays of all the operations, it is necessary to always update the timetable based on the latest information. In other words, if there are some changes in the departure/arrival time of airplanes due to weather conditions, aircraft troubles, crowdedness of airway, etc., it is necessary to immediately and timely provide adequate information for all concerned organizations, airport companies, airlines, passengers, people who come to see off or meet the passengers, etc.

The present invention is capable of building such an airport general information communication system for public use and establishing a rational and adequate information control system for airport facilities and convenient facilities. The passengers and people who come to see off or meet the passengers can obtain, with a fixed information terminal apparatus, a portable phone or a portable information terminal, safe and accurate information for reservations, inquiries and contact from any location at any time in 24 hours.

The passengers can always use all the airport general information communication systems at the IT general information smart center. Moreover, the passengers can collect, allocate, classify and use data in respect of risk management information concerning aircraft accidents and hijack, boarding guide information, reservation and purchase of airplane thickets or ship tickets, and check-in procedures by IT techniques using an image-attached smart passport card or a portable phone function.

In particular, a personal portable phone allows two-way communications irrespective of positions by using the international standard IMT-2000. It is easy to use the portable phone by Java (registered trademark) programs, and the use of the portable phone enables rapid contact in the case of emergency. By connecting a portable phone to a server in the IT general information smart center, all the airport information is obtainable, and a variety of information, reservations, inquiries, contact and reporting of position become available by two-way communications.

Moreover, according to the present invention, a large-sized display unit is provided in the international and domestic arrivals/boarding guide large hall. It is therefore possible to display administration information, risk management information, financial information, exchange information, currency exchange rates, etc., as well as flight information.

Furthermore, according to the present invention, a portable phone can function as information obtaining means capable of communicating with a facility server, and can be used as a unit for transmitting, from the facility server, a variety of information, reservations, various kinds of inquiries and informative matters. The information is mainly transmitted by e-mail. Upon the input of the contents of an image-attached smart passport card into the facility server, the facility server reads the passport number from the image-attached smart passport card. When there is an inquiry from a portable phone or a portable information terminal with the corresponding passport number, boarding status, various kinds of reservation status, the checked baggage information, travel guide, etc. are sent to the portable phone, and guarded there. In addition, it is also possible to send forced contact messages for various kinds of informative matters, urgent contact and boarding check to a portable phone or a portable information terminal from the facility side over a communication network.

According to the present invention, since the portable phone can be used as means for detecting a passenger's position in the facility, it is possible to provide efficient services such as guide services for passengers.

According to the present invention, a variety of information (personal information, the contents of boarding pass, passport information, etc.) described in the image-attached smart passport card can be displayed using a portable phone as a display unit.

As described above, in order to provide adequate airport information for a large number of passengers of super jumbo airplanes which will be placed in 2005, the passenger moving space guide system of the present invention integrates and centralizes various kinds of separate information, and contains flight control operation information of the airport authorities and government information about customs, immigration/emigration, quarantine, etc. which were not announced for passengers. As a result, the system of the present invention can be used for passengers' various purposes. Moreover, by newly building a wide spacious large hall capable of accommodating a large number of passengers, every passenger can enjoy comfortable environment conditions safely, security of airport is ensured, and normal operations of airplanes can be achieved.

As a result of adopting the present invention, it becomes possible to minimize the enlargement and reconstruction of the airport facility, save space by efficient space utilization, and safely and quickly process the boarding and deplaning of a large number of passengers.

In major international airports in Europe and America, by using information provided for airlines, such as aeronautic information and airport facility information, as the nucleolus, an airport information communication system for passengers is implemented according to the international standards and recommended practices of Annex 15 to the Convention of International Civil Aviation. The present invention functions as a system containing life style information such as general information of various kinds of contents, and realizes the world's first airport general information communication system exhibiting international economic information, particularly financial information, exchange information and stock-price information, which has not been implemented in the major international airports in Europe and America.

Annex 9 to the Convention of International Civil Aviation includes Recommended Practice 6.12 which recommends that contracting states should install a flight information notice board or a display unit comprising a public broadcast loudspeaker capable of transmitting information by clear voice so as to enable passengers and the public to receive sufficient information about arrivals, departures and cancellation of flight, and completely convey information, especially information concerning the final change in the departure and arrival time or change in the boarding gate number. The present invention sufficiently satisfies this recommendation.

A recommended practice in Annex 9 recommends to complete the departing formalities as soon as possible, and, if possible, not to request the passengers to go through inspections more than normal inspections concerning international air transportation so as to complete departure formalities from the first check point in an airport (airline's check-in counter, security inspection area or other location determined by individual airport) in a total of 60 minutes so that the security inspections are completed by the defined departure time of flight. Moreover, a recommended practice in Annex 14 recommends to review the safe and efficient use of the passenger terminal facilities and to sufficiently consider the environmental security for passengers. If the actual time greatly exceeds the time required for these formalities, then the airport authorities, passenger service providers and control authorities are recommended to consult with a concerned air transport party about measures to achieve the expected time.

According to the aeronautic information services defined in Annex 15, contracting states have an obligation to announce the contents of immigration/emigration control services (Customs, Immigration and Quarantine) and time available in their international airports.

According to the present invention, a variety of airport information is newly created for safe and rapid boarding and deplaning of a large number of passengers on/from airplanes, simplification of immigration/emigration inspections, customs inspections and check-in, and security countermeasure. Accordingly, it is possible to improve security countermeasure to prevent crowdedness, congestion and accidents in the airport facility, rationalize enlargement and reconstruction of the airport facility, save labor for operation, and ensure a smooth flow of passengers, thereby realizing a comfortable environment for passengers.

The international and domestic arrivals/boarding guide large hall dispenses with all the conventional facilities such as airlines' check-in counters, general waiting rooms, air travel agent facilities, convenient service facilities for passengers and a departure lobby, and newly includes these facilities in a comprehensive manner. As a result, it becomes possible to prevent accidents such as scattering of a large number of passengers, incorrect boarding and flight missing.

The above and further objects and features of the invention will more fully be apparent from the following detailed description with accompanying drawings.

### BRIEF DESCRIPTION OF THE SEVERAL VIEWS OF THE DRAWINGS

FIG. 1 is an explanatory view of the emigration facility in an airport passenger terminal, for illustrating one embodiment of a passenger moving space guide system of the present invention;

FIG. 2 is an explanatory view of the immigration facility in an airport passenger terminal, for illustrating one embodiment of a passenger moving space guide system of the present invention;

FIG. 3 is an explanatory view showing a flow of information at an IT general information smart center;

FIG. 4 is a plan view showing one example of the IT general information smart center;

FIG. 5 is a side view showing one example of the IT general information smart center;

FIG. 6 is an explanatory view of terminal apparatuses for obtaining information at the IT general information smart center;

FIG. 7 is an explanatory view of information providing services at the IT general information smart center;

FIG. 8 is an explanatory view of an image-attached smart passport card;

FIG. 9 is an explanatory view showing a flow of processing of an image-attached smart passport card;

FIG. 10 is a front view showing an example of the screen of a large-sized display unit;

FIG. 11 is a front view showing an example of the screen of a fixed information terminal apparatus;

FIG. 12 is an explanatory view showing an example of use of a portable phone;

FIG. 13 is an explanatory view showing a screen example of use of a portable phone;

FIG. 14 is an explanatory view showing another example of use of a portable phone; and

FIG. 15 is an overall explanatory view showing an example of use of a portable phone according to the present invention.

### DETAILED DESCRIPTION OF THE INVENTION

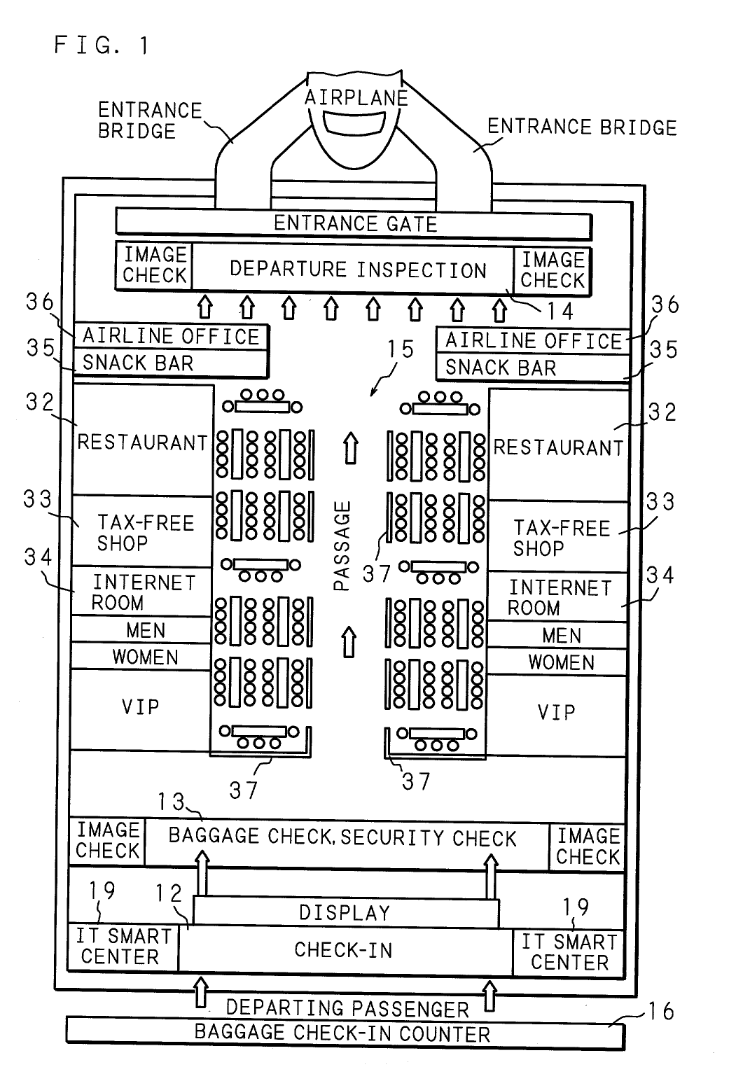

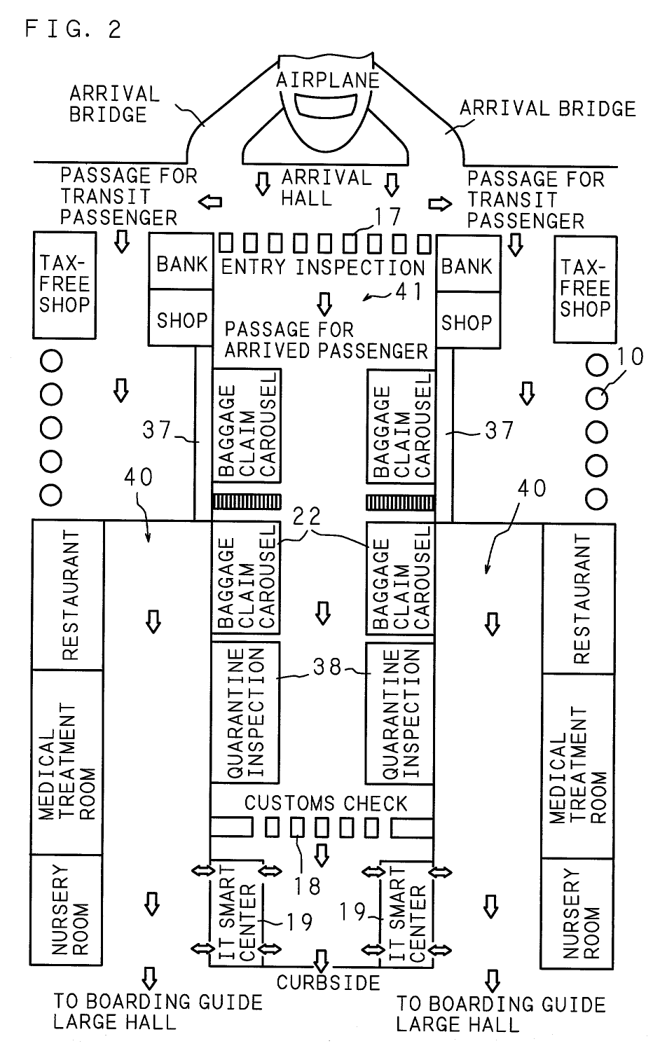

The following description will explain an embodiment of the present invention in detail with reference to the drawings. FIG. 1 is an explanatory view of the emigration facility in an airport passenger terminal, for illustrating one embodiment of a passenger moving space guide system of the present invention, and FIG. 2 is an explanatory view of the immigration facility in the airport passenger terminal.

A boarding guide large hall (a hall) 15 that functions as the emigration facility includes: a passenger check-in facility 12 for accepting check-in; a security facility 13 for performing security inspections to prevent hijacking; and an emigration inspection facility 14 provided along with the security facility 13. Further, in the boarding guide large hall 15, a boarding guide facility, and shop, snack bar and restaurant facilities are comprehensively provided. A baggage check-in facility 16 is located in front of the entrance of the airport passenger terminal building, such as the curbside and parking space.

In order to realize a smooth flow of a number of passengers and rapid boarding formalities, and to prevent crowdedness and accidents, the boarding guide large hall 15 as one hall of the international and domestic arrivals/boarding guide large hall dispenses with all the conventional facilities such as airlines' check-in counters, general waiting rooms, air travel agent facilities, convenient service facilities for passengers, and a departure lobby, and newly includes these facilities in a comprehensive manner. In the boarding guide large hall 15, all the convenient service functions for passengers such as the Internet rooms, conference rooms, nursery rooms, medical treatment rooms, restaurants, snack bars and shops as well as the passenger check-in facility for accepting check-in, emigration inspection facility, passenger boarding guide facility, air travel agent functional facility, and airlines' passenger reception facility are comprehensively provided. In the drawings, 32 and 35 are restaurants and snack bars for food, drink and coffee, 33 is a tax-free shop for selling goods, 34 is an Internet room, 36 is an airline office including the passenger boarding guide facility, air travel agent functional facility and airline's passenger reception facility.

Provided in the boarding guide large hall 15 is a large-sized display unit 37 for announcing administration information, risk management information, financial information, exchange information and currency exchange rates as well as flight information.

In front of the security facility 13, an IT general information smart center (an information center) for confirming fright reservations and travel information is provided along with the passenger check-in facility 12. In this IT general information smart center 19, fixed information terminal apparatuses 10 connected to an airport general information communication network (LAN) 9 are provided. The IT general information smart center 19 provides a variety of information including various kinds of boarding information for each passenger by using, as keys, oral announcement, a portable phone 31 and an image-attached smart passport card 1 which is an IC card provided with the passport function, airplane ticket or ship ticket function and credit card function.

The IT general information smart center 19 has a server 8 that communicates with a variety of information servers of states, airlines, airport companies and air travel agents. The server 8 immediately announces information necessary for passengers by creating or integrating and centralizing aeronautic information, boarding guide information, flight control information, aviation weather information, airport facility information, risk management information, administration information, financial and exchange information, etc. which are not conventionally announced for passengers, as well as boarding guide information and check-in procedure information.

The server 8 is connected to: public organization servers owned by the ministry of foreign affairs who issues passports and by official certificate issuing organizations such as a public office having the resident basic ledger; external private servers of airlines, travel agents, shops and external inquiry centers such as banks, which have card inquiry, settlement process, time series details logs as files; and an airport/seaport terminal server which has files of the management ledger in the airport or seaport terminal, check-in and emigration control. The server 8, public organization servers, external private servers and airport/seaport terminal server are connected together by a communication network such as the Internet to form the airport information communication network (LAN) 9.

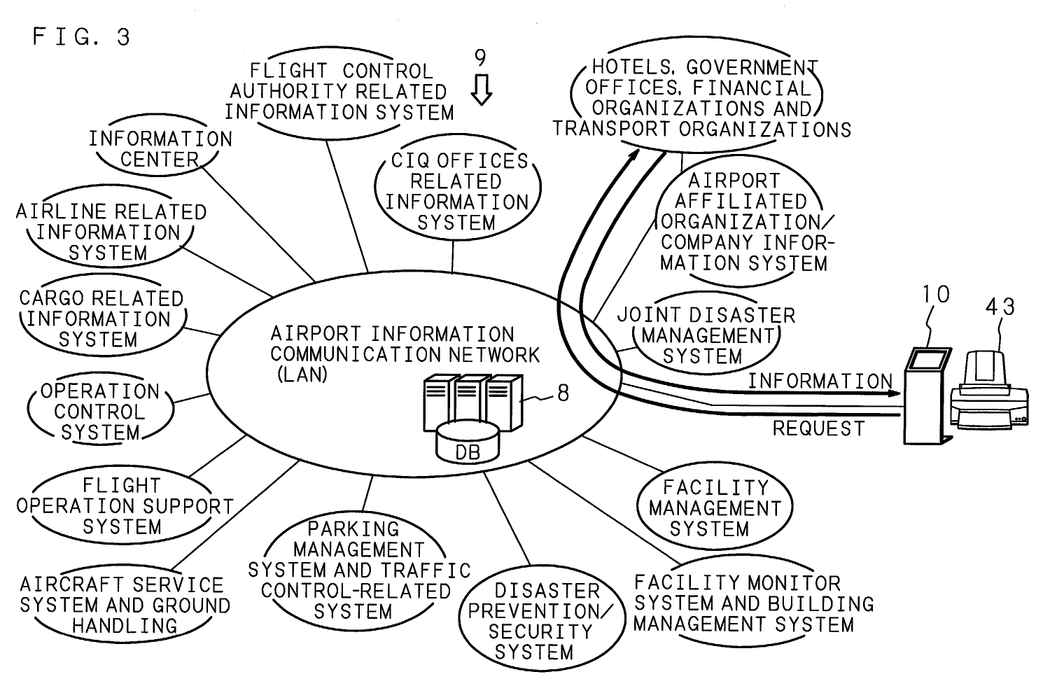

FIG. 3 shows the airport information communication network (LAN) 9. In the airport information communication network (LAN) 9, for example, an information center, airline related information system, cargo related information system, flight control authority related information system, CIQ offices related information system, hotels, government offices, financial organizations, transport organizations, airport affiliated organization/company information system, joint disaster management system, operation control system, flight operation support system, aircraft service system, ground handling, parking management system, traffic control-related system, disaster prevention/security system, facility monitor system, building management system, facility management system, and the fixed information terminal apparatuses 10 can communicate with each other.

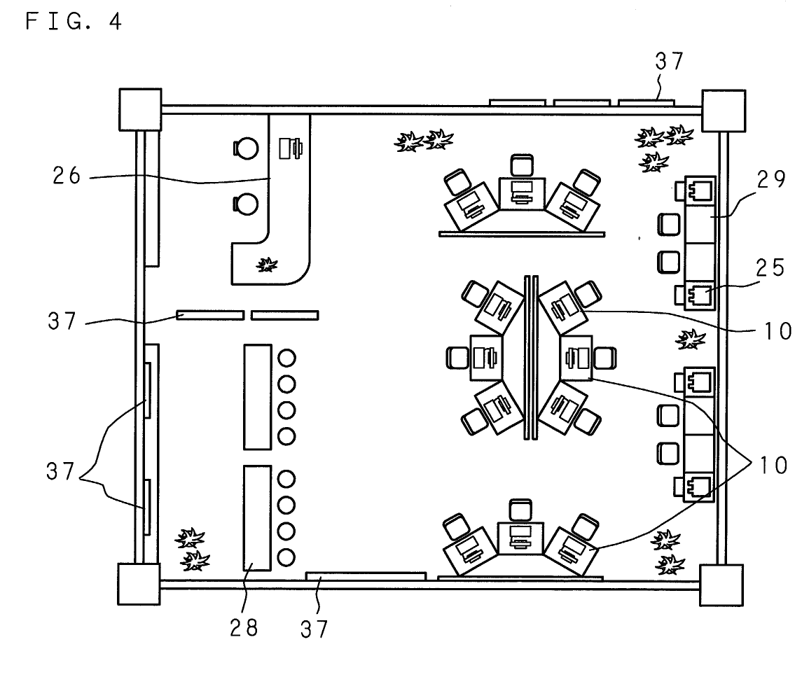

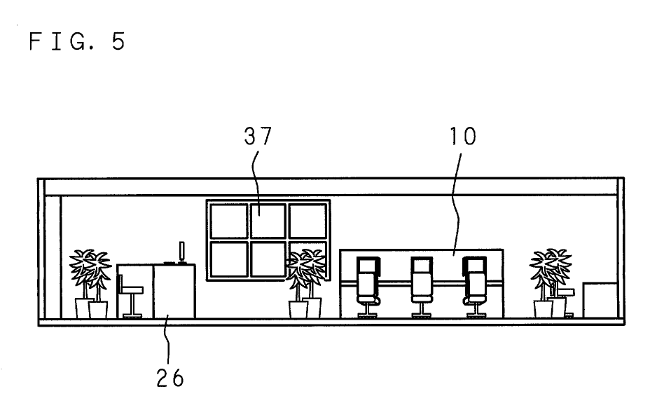

The IT general information smart center 19 may be provided as a lobby inside the airport facility. FIGS. 4 and 5 show one example thereof. In FIGS. 4 and 5, a number of fixed information terminal apparatuses 10 are provided. With the use of the fixed information terminal apparatus 10, it is possible to confirm, inquire and notify personal information and also to obtain information about travel in general. The fixed information terminal apparatus 10 include functions such as a single board computer, Ethernet (registered trademark), an ultrasonic high-sensitive touch panel, memory, HDD, a smart card reader, a heat-transfer type printer 43, an auto-cutter, a two-way voice panel, and an automatic image communication panel, and uses the information at the time of boarding on an airplane.

In the drawings, 26 represents the reception in the IT general information smart center 19, 27 is a plasma display, 28 is a snack bar counter, and 29 is a work area where users can use their own terminal apparatuses.

Note that there may be a case where the IT general information smart center 19 is not provided as an airport facility created by marking off a certain area like a lobby. In this case, the IT general information smart center 19 possesses only a server, and the fixed information terminal apparatuses 10 are provided in a dispersed manner.

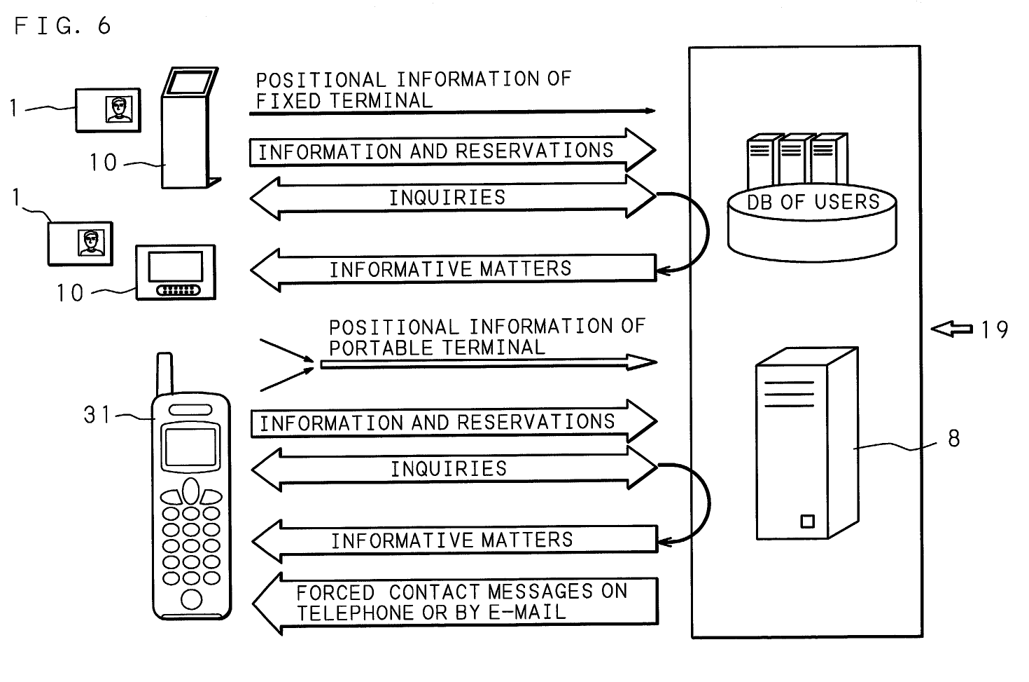

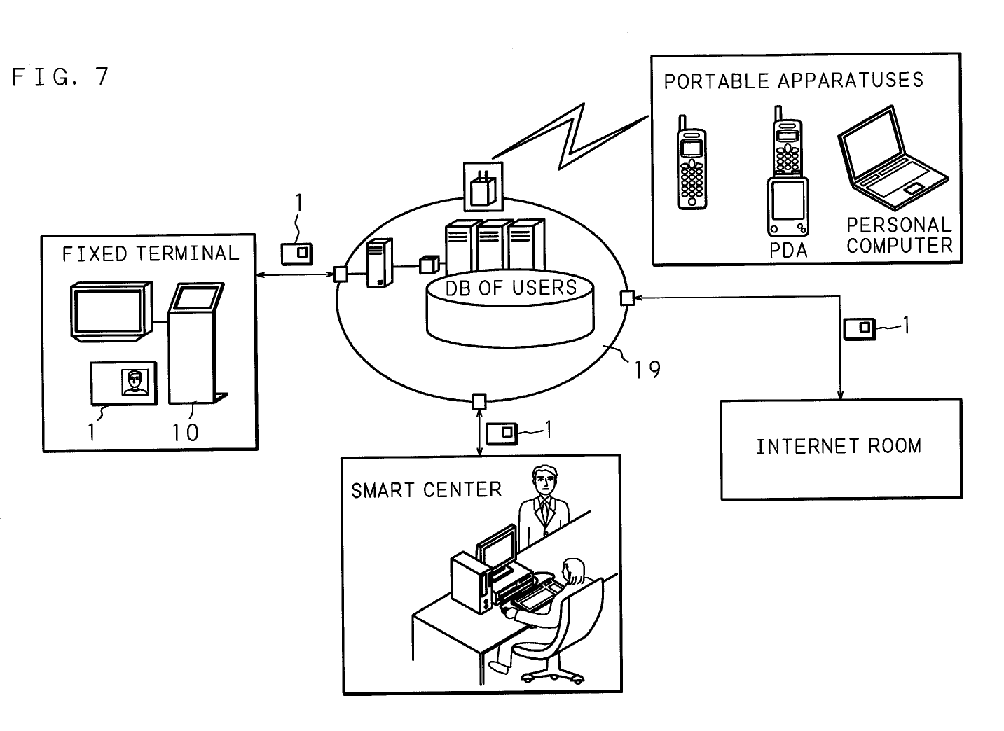

In both of the case where the IT general information smart center 19 is provided as a lobby in the airport facility and the case where it is not provided as a lobby, the means for obtaining information from the IT general information smart center 19 can be a fixed information terminal apparatus 10 provided in a specific location or other locations, a fixed information terminal apparatus 10 as a special portable terminal apparatus as shown in FIGS. 6 and 7, a portable phone 31, or a portable information terminal or a PDA (Personal Digital Assistant).

Meanwhile, as shown in FIG. 2, the immigration facility includes a passenger immigration inspection facility 17 for performing immigration inspections; a customs check facility 18 for making inspections of baggage, etc.; a quarantine inspection facility 38 for inspecting animals and plants; a baggage claim carousel 22 as a baggage conveying facility; and a transit passenger waiting room 40 as a transit facility. An arrival guide large hall 41 is formed to enclose the immigration inspection facility 17, customs check facility 18 and quarantine inspection facility 38.

The arrival guide large hall 41 as one hall of the international and domestic arrivals/boarding guide large hall further includes an IT general information smart center 19 like the one in the boarding guide large hall 15, in addition to the tax-free shops, facilities such as shops, snack bars and restaurants, banks, medical treatment rooms, nursery rooms, etc. Moreover, in the arrival guide large hall 41, the fixed information terminal apparatuses 10 are provided in a suitable manner so that various kinds of immigration information, such as immigration information and transit information, is obtainable.

Furthermore, like the boarding guide large hall 15, this arrival guide large hall 41 also includes a large-sized display unit 37 for announcing administration information, risk management information, financial information, exchange information and currency exchange rates as well as flight information.

For leaving a country, a departing passenger first goes through a baggage check-in inspection at the baggage check-in facility 16 in the passenger terminal building curbside or parking space. The passenger brings his/her passport and image-attached smart passport card 1 when leaving his/her house, and checks in his/her baggage for issuance of tag RFID (Radio Frequency Identification) at the baggage check-in facility 16 that is a baggage check-in counter. Note that the baggage may also be checked in advance.

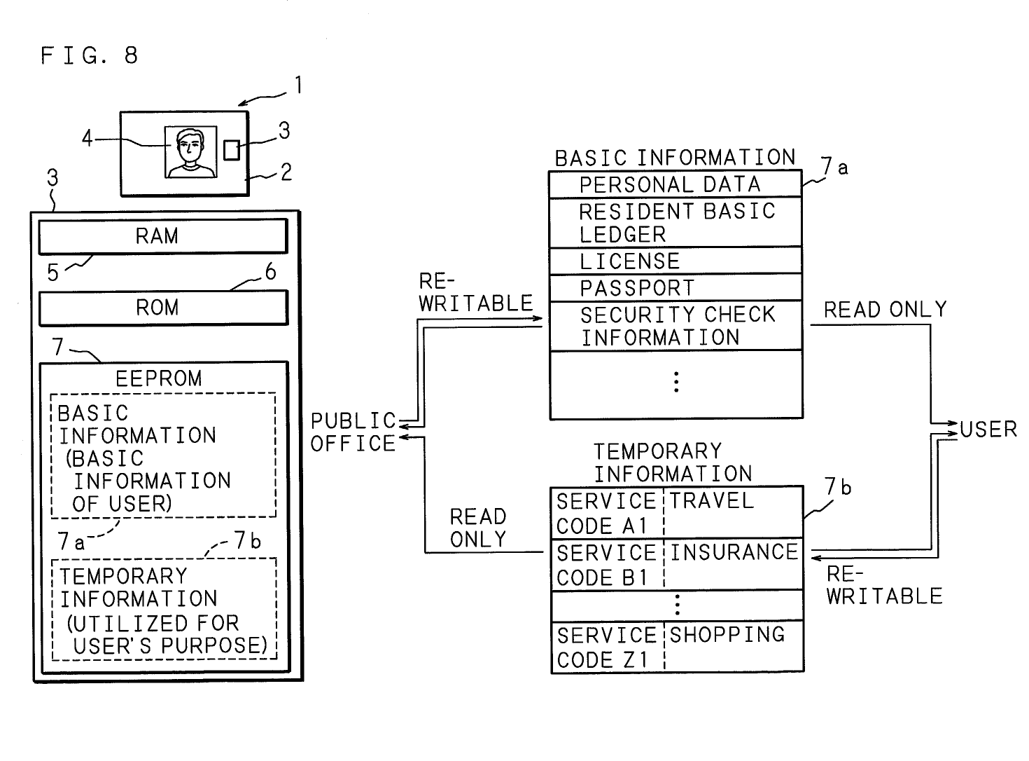

In order to explain the image-attached smart passport card 1, one example thereof is shown in FIG. 8. The image-attached smart passport card 1 is an IC card having an IC memory chip 3 embedded in a card body 2 and a photograph 4 of the upper half of body, attached to the front side thereof.

The IC memory chip 3 includes a RAM 5 and a ROM 6 as memories used by the system, and an EEPROM memory 7 that is an area usable by the user.

The EEPROM memory 7 is divided into an area for basic information 7a that is determined as a fixed format, and an area for temporary information 7b that can be utilized for the user's purpose. The basic information 7a is information issued by official certificate issuing organizations and other authentication-related living basic functional information, such as passport-related information including the image data of a photograph of the upper half of body (same as the photograph 4), security check information (such as a password and a finger print/palm print information), the resident basic ledger (resident identification card), the certificate of registered seal impression, national pension, long-term care insurance, driving license, health insurance card, national health insurance card, mutual aid association card, pension card, student card, identification card issued by a company, a copy of one's family register and an extract of one's family register.

The passport-related information includes the term of validity of a ten-year passport or five-year passport, the length of stay in the main destination and the expected date.

The basic information 7a also includes data for biometric verification, such as a finger print and a palm print.

On the other hand, as the temporary information 7b, financial settlement-related information such as information about the bank account is inputted to provide the image-attached smart passport card 1 with an electronic settlement function for foreign travel. The temporary information 7b further includes: travel-related support information about airplane tickets, hotels, reservations, etc.; personal information about insurances, employment, etc.; and other various information about weather, stock prices, etc.

The temporary information 7b includes service codes, for example, A01 for travel, B01 for insurance, C01 for shopping, and so on. Each industry can freely determine the format of the data area for each service code. Moreover, authentication and encipherment methods can also be freely determined by the industry.

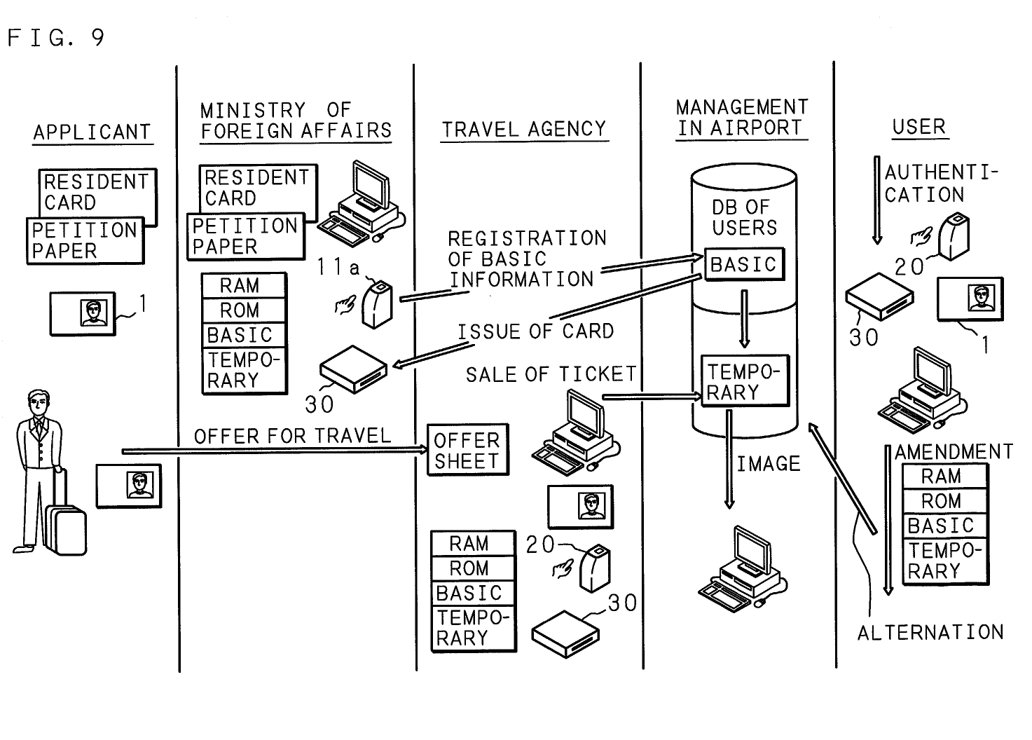

Next, referring to FIG. 9, the following description will explain the flow of processes of issuing a passport and purchasing an airplane ticket or ship ticket using the image-attached smart passport card 1. A passenger purchases a passenger card having an electronic settlement function from a card issuing company in advance. The passenger submits this passenger card together with an application when applying for a passport, and receives an image-attached smart passport card 1 created by including and embedding the data described on the passport, the person's identification data and photograph and/or finger print in the passenger card at the time of issuance of the passport. Note that the passport issued by the ministry of foreign affairs may be issued to the applicant with a smart card enclosed, and the person receiving the smart card may validate the electronic transaction settlement function later. It is also possible that the person may ask a financial organization for authorization to add the electronic transaction settlement function.

The airplane ticket or ship ticket is purchased using this image-attached smart passport card 1. For purchasing the airplane ticket or ship ticket, necessary data is inputted in the image-attached smart passport card 1 at a travel agent, airline, shipping company which has services on a foreign route, kiosk, etc., instead of ticketing the airplane ticket or ship ticket. Data necessary for check-in operations, such as the airline/shipping company to be used, destination, fare and boarding seat number, is inputted in the image-attached smart passport card 1 in addition to the passenger number and the person's identification data.

When the user directly visits a travel agent, airline or shipping company, the data of the purchased airplane ticket/ship ticket is inputted (in a standard format) in the image-attached smart passport card 1 by using a terminal apparatus 30 (I/O device) [fixed terminal] of that agent. The electronic transaction settlement function is added to the image-attached smart passport card 1. Tag RFID (Radio Frequency Identification) is also issued. RFID can be reissued by the terminal apparatus 30 if it is lost.

For the purchase/reservation by the image-attached smart passport card 1 through a telephone, a FAX or the Internet, if the user's PC (personal computer) has a terminal apparatus 30 (I/O device), the airplane ticket/ship ticket data is downloaded to the image-attached smart passport card 1. When the purchase/reservation is made through a telephone or when the PC has no terminal apparatus 30 (I/O device), the purchased airplane ticket/ship ticket data is downloaded to the image-attached smart passport card 1 later using a fixed terminal.

The payment is made using a credit card or the settlement function of the image-attached smart passport card 1. When the user uses the settlement function, if the user's PC has a terminal apparatus 30 (I/O device), it is possible to use electronic money, a debit card and a credit card. In other cases, only a credit card can be used (payment is completed by just informing a seller of the card number).

When the purchase was made by the image-attached smart passport card 1 through a telephone/the Internet, the user downloads the airplane ticket/ship ticket data through a fixed terminal by the date of departure. The languages to be used are the official languages of the United Nations. For example, the system may be designed to determine a language to be used based on the nationality information stored in the basic information 7a of the image-attached smart passport card 1 or the nationality information contained in the customer information accessed by the servers, and to download the airplane ticket data in the determined language. The user who purchased the ticket at an agent, etc. can also rewrite the data if there is some change. The verification of the person is made by the identification number or biometrics. With the use of the image-attached smart passport card 1 in which the data is written, it is possible to monitor the movement of the person by electronic waves until he/she boards the airplane/ship. Therefore, the staff can promptly guide passengers who have not yet on board at the last moment of departure to get on an airplane/ship.

Upon writing the data in the image-attached smart passport card 1, necessary pieces of RFID (Radio Frequency Identification) written in the standard format are issued. The flight/service number, destination, etc. are written in RFID. RFID is issued at the travel agent in advance, based on the data inputted in the image-attached smart passport card 1.

In the periphery of the entrance of the facility, the passenger enters the lobby of the IT general information smart center 19. In the lobby, all the information about boarding, the check-in procedure at the passenger check-in facility 12, and the travel agent functional facility for reservation and purchase of airplane tickets are automatically confirmed using the fixed information terminal apparatus 10 with the image-attached smart passport card 1 and/or portable phone 31.

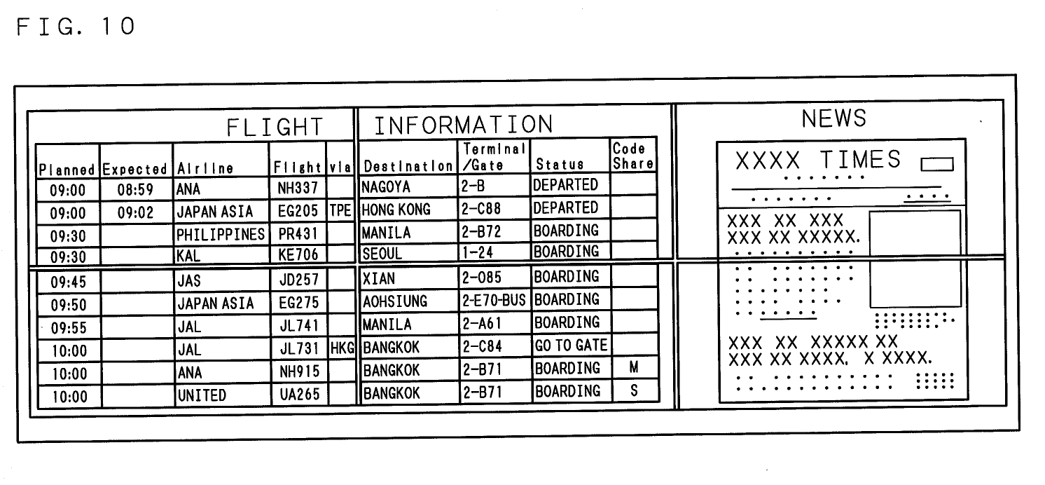

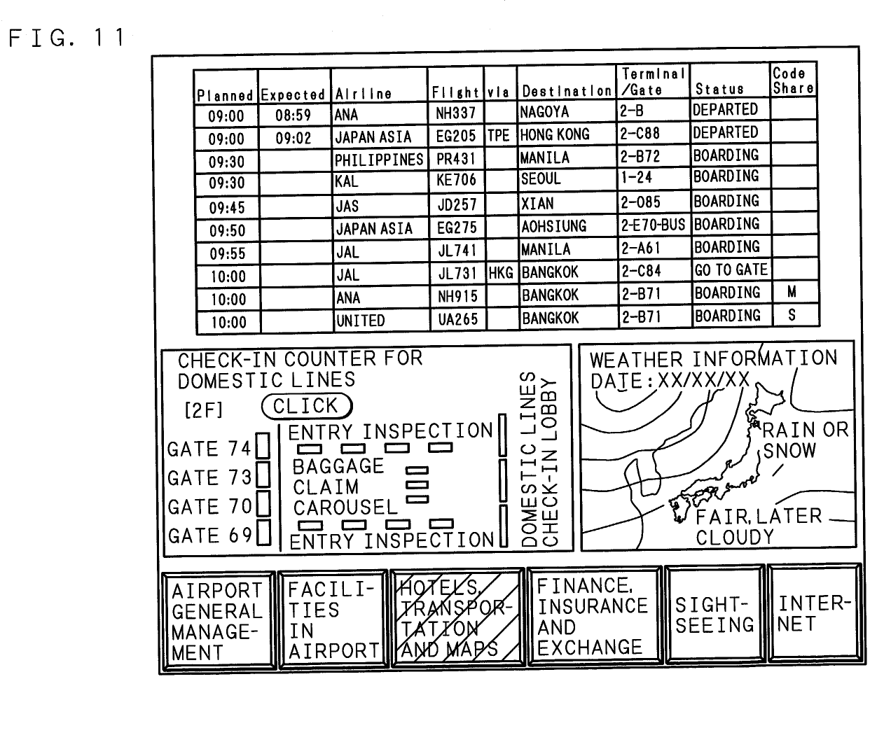

FIG. 10 shows an example of the screen of the large-sized display unit 37. FIG. 11 shows an example of the screen of the fixed information terminal apparatus 10. The fixed information terminal apparatus 1 provides guide information on travel in general as well as boarding information, and confirmation, inquiry and notification of personal information through the airport information communication network (LAN) 9.

At the passenger check-in facility 12, a check-in is accepted through personal verification based on the image-attached smart passport card 1 and the confirmation of the boarding pass based on the image-attached smart passport card 1. For the verification of the person, the passenger inserts his/her image-attached smart passport card 1 into the terminal apparatus 30 (I/O device), selects the language to be used and drawing/voice, and places his/her finger or palm on a finger print/palm collator (personal verification by biometrics). Moreover, the image of the photograph of the face is displayed on a monitor to collate it with the face of the person. At the passenger check-in facility 12, the baggage tag, the boarding seat number, etc. can also be confirmed.

In the security inspection area of the security facility 13, the passenger indicates the status of the boarding pass by showing information such as the specified boarding seat obtained by the image-attached smart passport card 1 and portable phone 31 on a display, for confirmation by the inspector. The passenger goes through a metal detector and body check to pass through the security facility 13.

The passenger who has gone through the confirmation of boarding enters the boarding guide large hall 15. In the boarding guide large hall 15, the passenger can use convenient services such as the Internet, conference rooms, nursery rooms, snack bars, restaurants, and shops until the boarding standby time, and can also use the fixed information terminal apparatus 10 to confirm the boarding information, travel information, etc., for conformation or correction of his/her travel plan. In the boarding guide large hall 15, the payment for meals and shopping at snack bars, restaurants, tax-free shops, etc. can be made with the image-attached smart passport card 1. Moreover, cash advance services to have cash are also available with this image-attached smart passport card 1.

According to the boarding guide information on the large-sized display unit 37 or the like, the passenger inputs information such as the specified seat obtained by the image-attached smart passport card 1 and the portable phone 31 to a display at the inspection gate of the emigration inspection facility 14 in the emigration inspection area, and boards an airplane via the boarding pathway when approved by the inspector.

Like the above, though not illustrated by drawings, the domestic departure facility includes: an IT general information smart center 19 for confirmation of flight reservations, travel information, etc.; the facility of the fixed information terminal apparatuses 10 established with the airport general information network (LAN) 9; a security facility 13 for performing security inspections to prevent hijacking; a boarding guide space facility; and a boarding facility.

It is the same in this case that various kinds of boarding information for passengers is available through the fixed information terminal apparatuses 10 in the IT general information smart center 19 by using, as keys, oral announcement, a portable phone 31 and an image-attached smart passport card 1 which is an IC card having airplane ticket or ship ticket and credit card functions.

Moreover, the domestic departure facility also secures a moving space for a large number of passengers by providing a boarding guide large hall 15 so as to prevent accidents, such as scattering of the passengers, incorrect boarding and flight missing, and cause passengers to gather in a certain area in a short time for rapid and smooth boarding.

On arrival, i.e., for entering a country, as immigration formalities, like the emigration formalities, personal verification based on the image-attached smart passport card 1 and, if necessary, an immigration inspection based on the confirmation of flight are carried out at the immigration inspection gate that is the immigration inspection facility 17.

Baggage is carried to a predetermined baggage claim carousel (turntable) 22 corresponding to the passenger's flight, based on the data of RFID (standard format) attached to his/her baggage at the time of departure. Even when a plurality of baggage claim carousels 22 are used, each passenger's baggage is managed as a unit. The baggage is grouped for each baggage claim carousel 22 according to transit, seats and other factors, and the information is displayed on a large-sized screen.

In the customs check facility 18, the passenger goes through a customs check by inserting the image-attached smart passport card 1 into a terminal apparatus 30. In an inspection area 23, the terminal apparatus 30 is provided as an automatic duty inspecting terminal apparatus. It is possible to obtain the baggage declaration card information, perform an automatic customs inspection card declaration inspection, and withdraw taxes, based on the image-attached smart passport card 1.

As the arrival facility, an arrival guide large hall 41 is provided including a transit facility, a baggage conveying facility and an arrival facility. An IT general information smart center 19 and fixed information terminal apparatuses 10 are placed in the arrival guide large hall 41. Therefore, each passenger can obtain a variety of information about his/her transit airline, flight number, departure time, immigration/emigration formalities, customs formalities, and baggage processing.

Domestic arrival passengers pass through the connection pathway from their airplanes, collect their baggage in the baggage conveying facility, and proceed to the exit after the confirmation of the baggage by the airline's baggage inspecting device. When the passengers possess only carry-on baggage, they proceed directly to the exit via the arrival passenger pathway. Transit passengers confirm their flight reservations for transit airplanes through the IT general information smart center 19 and the fixed information terminal apparatuses 10 in a boarding guide large hall including a lobby exclusively for transit purpose, by using their image-attached smart passport cards 1 or portable phones 31, and then wait.

In all of the above-described cases, all the airport general information communication systems 9 are always available through the IT general information smart center 19 and the fixed information terminal apparatus 10. Moreover, with the functions of the image-attached smart passport card 1 or portable phone 31, it is possible to collect, allocate, classify and utilize data by IT techniques, for the confirmation of risk management information about aircraft accidents and hijacks, and boarding guide information, the reservation and purchase of airplane tickets or ship tickets, and the check-in procedures.

As shown in FIG. 6, the portable phone 31 can be used not only as the means for obtaining information from the IT general information smart center 19, but also as a unit for transmitting information from the facility server 8.

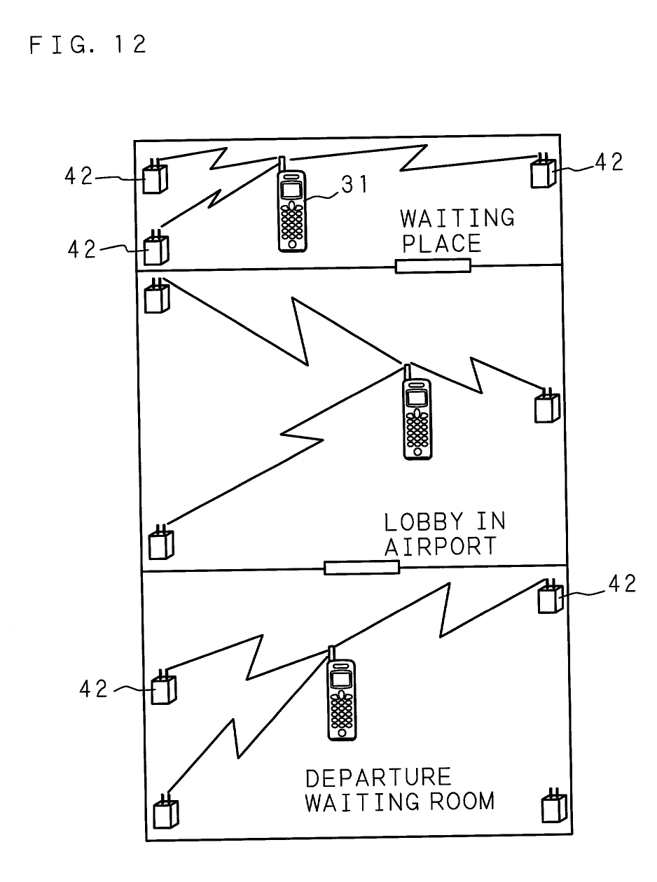

Furthermore, the portable phone 31 can be used for an automatic position detection based on triangulation station by providing antennas 42 for confirming a position at three separate locations as shown in FIG. 12.

Accordingly, a variety of information, reservations, various kinds of inquiries and informative matters are available by e-mail from the facility server 8, by using the portable phone 31. Upon the input of the contents of an image-attached smart passport card 1 into the facility server 8, the facility server 8 reads the passport number from this image-attached smart passport card 1. When there is an inquiry from a portable phone 31 with the corresponding passport number, boarding status, various kinds of reservation status, checked baggage information, travel guides, etc. are sent to the portable phone 31, and guarded there. Furthermore, it is also possible to send forced contact messages for various kinds of informative matters, urgent contact, boarding check, etc., on telephone or by e-mail from the facility side to a portable phone.

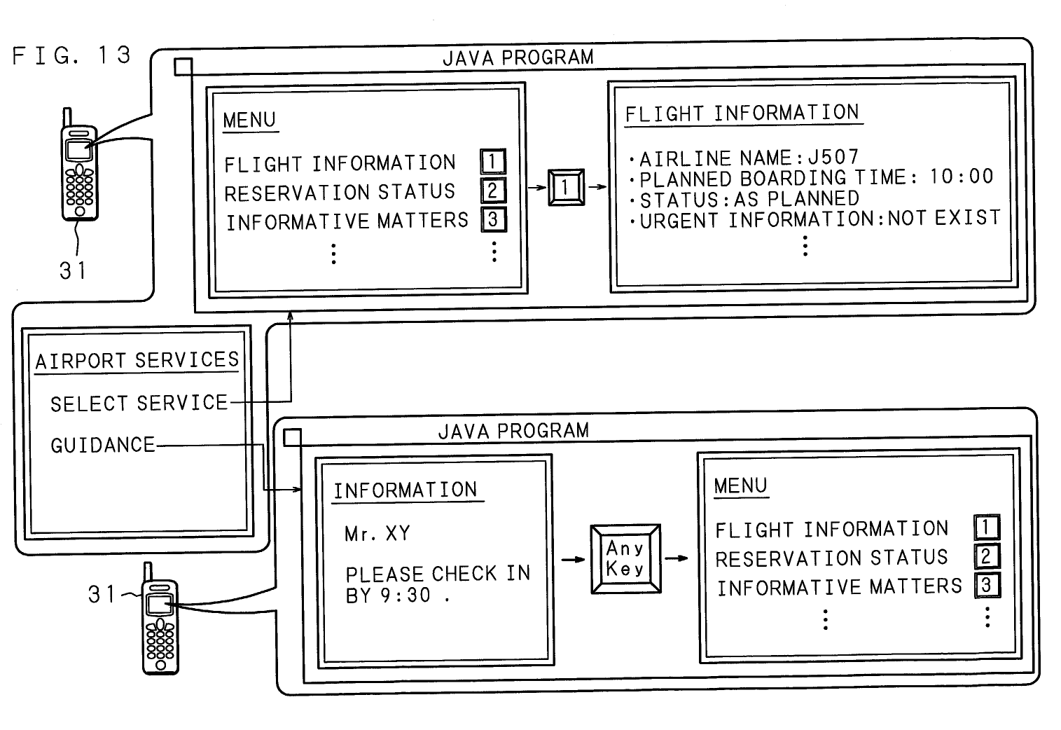

FIG. 13 is an explanatory view explaining how the information is provided and how the guide information based on position is provided. Service menus are allocated to a portable phone for selecting information by automatic recognition of the portable phone number of a portable phone 31 and to phone buttons that provides inquired information by the input of the passport number.

Regarding the guide information service based on position, when a passenger arrived at an airport, for example, check-in information/guide, such as the gate number and the remaining time, is provided through his/her portable phone 31. Note that, though not illustrated, this portable phone 31 can also be used to make prior notice at a certain time and forced contact with the passenger who has not gone through the procedures.

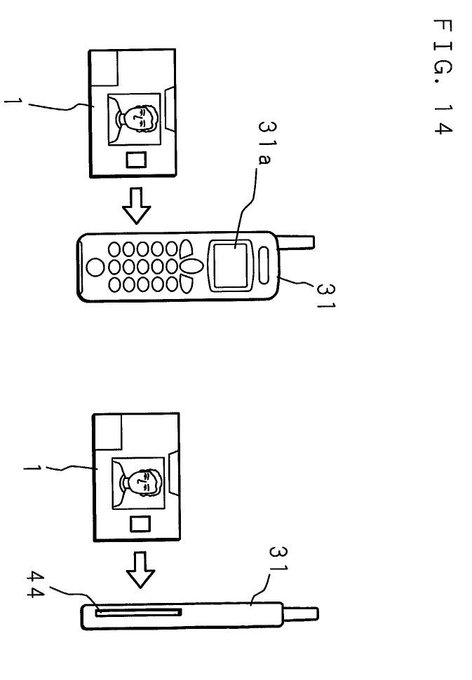

FIG. 14 shows another method of using the portable phone 31. The portable phone 31 includes a reader 44 for reading an image-attached smart passport card 1 which is an IC card having the passport function, airplane ticket or ship ticket function, and credit card function, and can display the contents stored in the memory of the image-attached smart passport card 1 on the display screen 31a of the portable phone 31.

Consequently, a variety of information (such as personal information, boarding pass contents, and passport information) described in the image-attached smart passport card 1 can be displayed by using the portable phone 31 as a display unit.

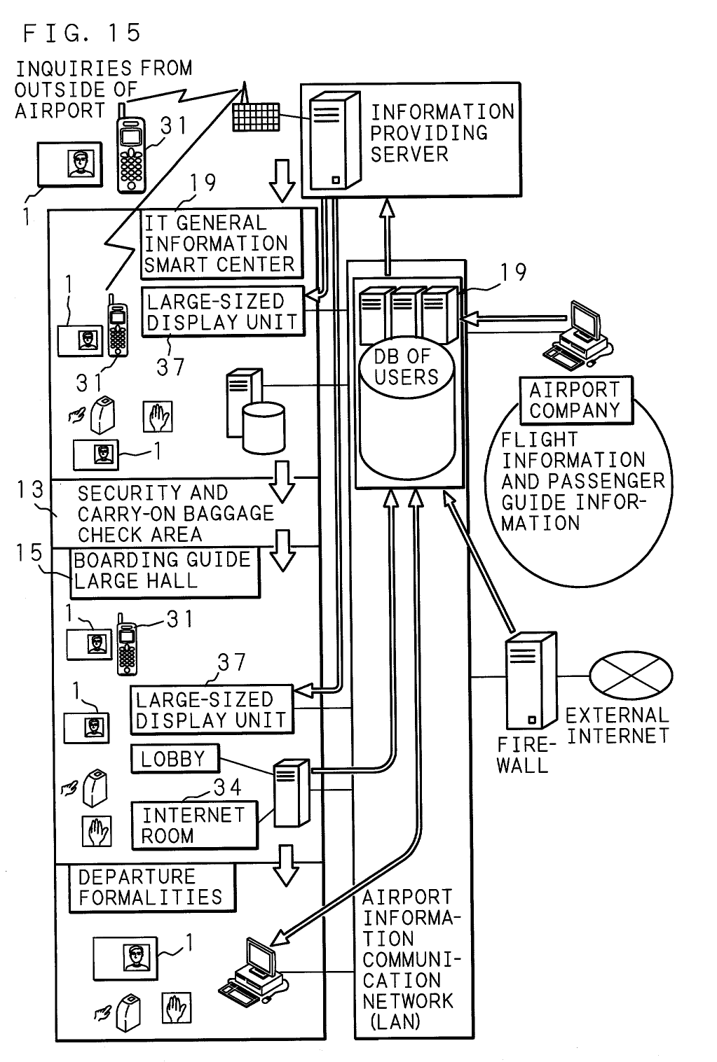

FIG. 15 shows the abstract of a system of the present invention which uses the portable phone 31. Note that authentication to permit to use the system is made based on a finger print or password for security purposes. With this configuration, the present invention can be used safely in spite of the possibility of being stolen.

Furthermore, the present invention may be arranged to enable access to the airport information communication network 9 by reading the airplane ticket information stored in the image-attached smart passport card 1 in advance with a portable phone 31 and using the airplane ticket information as a password. With this arrangement, it is possible to obtain a variety of information inside an airport from the outside of the airport and to display the information on the display screen 31a of the portable phone 31.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A system for guiding passengers who use a facility, comprising:
an information center located in periphery of an entrance/exit of the facility, where information and guide services related to travel are provided;
a security facility, located adjacent to the information center, for performing security inspections; and
a hall arranged along with the security facility, the hall comprising:
a passenger check-in facility for accepting check-in;
an immigration/emigration inspection facility;
a passenger boarding guide facility;
an air travel agent facility;
an airline's passenger reception facility; and
a convenient service facility for passengers, including at least one of a room where the passengers can access Internet, a conference room, a nursery room, a medical treatment room, a restaurant, a snack bar and a shop.

2. The system according to claim 1, further comprising:
a facility server, provided in the information center, for announcing necessary information for passengers in real time by communicating with at least one of information servers of states, airlines, airport companies and air travel agents, and integrating boarding guide information, check-in procedure information, and at least one of aeronautic information, boarding guide information, flight control information, aviation weather information, airport facility information, risk management information, administration information and financial and exchange information; and
at least one information obtaining unit selected from a fixed information terminal apparatus, a portable phone and a portable information terminal, the information obtaining unit being capable of communicating with the facility server.

3. The system according to claim 2, further comprising a large-sized display unit, provided in the hall, for announcing flight information, administration information, risk management information, financial and exchange information, and currency exchange rates.

4. The system according to claim 3, wherein at least one of the portable phone and the portable information terminal is used as a detecting unit for detecting a position of a passenger in the facility.

5. The system according to claim 4, wherein at least one of the portable phone and the portable information terminal includes a reader for an IC card having at least one of a passport function, an airplane ticket/ship ticket function and a credit card function, and displays contents stored in a memory.

6. The system according to claim 3, wherein at least one of the portable phone and the portable information terminal includes a reader for an IC card having at least one of a passport function, an airplane ticket/ship ticket function and a credit card function, and displays contents stored in a memory.

7. The system according to claim 2, wherein at least one of the portable phone and the portable information terminal is used as a transmitting unit for transmitting information from the facility server.

8. The system according to claim 7, wherein at least one of the portable phone and the portable information terminal is used as a detecting unit for detecting a position of a passenger in the facility.

9. The system according to claim 8, wherein at least one of the portable phone and the portable information terminal includes a reader for an IC card having at least one of a passport function, an airplane ticket/ship ticket function and a credit card function, and displays contents stored in a memory.

10. The system according to claim 7, wherein at least one of the portable phone and the portable information terminal includes a reader for an IC card having at least one of a passport function, an airplane ticket/ship ticket function and a credit card function, and displays contents stored in a memory.

11. The system according to claim 2, wherein at least one of the portable phone and the portable information terminal is used as a detecting unit for detecting a position of a passenger in the facility.

12. The system according to claim 11, wherein at least one of the portable phone and the portable information terminal includes a reader for an IC card having at least one of a passport function, an airplane ticket/ship ticket function and a credit card function, and displays contents stored in a memory.

13. The system according to claim 2, wherein at least one of the portable phone and the portable information terminal includes a reader for an IC card having at least one of a passport function, an airplane ticket/ship ticket function and a credit card function, and displays contents stored in a memory.

14. The system according to claim 1, further comprising a large-sized display unit, provided in the hall, for announcing flight information, administration information, risk management information, financial and exchange information, and currency exchange rates.

15. The system according to claim 14, wherein at least one of the portable phone and the portable information terminal is used as a detecting unit for detecting a position of a passenger in the facility.

16. The system according to claim 15, wherein at least one of the portable phone and the portable information terminal includes a reader for an IC card having at least one of a passport function, an airplane ticket/ship ticket function and a credit card function, and displays contents stored in a memory.

17. The system according to claim 14, wherein at least one of the portable phone and the portable information terminal includes a reader for an IC card having at least one of a passport function, an airplane ticket/ship ticket function and a credit card function, and displays contents stored in a memory.
